(19) United States
(12) Patent Application Publication
(10) Pub. No.: US 2005/0202246 A1
(43) Pub. Date: Sep. 15, 2005

(54) Glass panel for a cathode ray tube

(76) Inventors: Mohammed Khalil, Eindhoven (NL); Georgius Kuin, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/518,829

(22) PCT Filed: May 27, 2003
(86) PCT No.: PCT/IB03/02323

§ 371 Date: Dec. 21, 2004

(30) Foreign Application Priority Data
Jun. 28, 2002 (EP) 02077563.1

(51) Int. Cl. B32B 17/00

(52) U.S. Cl. 428/410

(57) ABSTRACT

The invention relates to a glass panel (2) for a cathode ray tube, in particular a real flat panel, comprising a substantially rectangular display window (5) having an upright edge (6) along its periphery. The glass panel (2) meets the following stress distribution criterion: S_{icor}>S_{icf} where Sicor is a compressive inside surface stress at a corner (19, 20, 21, 22) of the display window (5) and Sicf is a compressive inside surface stress at a center face (25) of the display window (5). Preferably, the ratio of S_{icor}/S_{icf} is higher than or equal to 1.05 and lower than or equal to 2.0. As a result of this particular stress distribution, the strength and the mechanical safety of the panel (2) are increased, so that the glass thickness of the panel (2) and/or thermal processing speeds may be reduced.

The present invention relates to a glass panel for a cathode ray tube, comprising a substantially rectangular display window having an upright edge along its periphery.

Nowadays, there is a tendency towards manufacturing larger panels having flatter front surfaces, which are generally referred to as real flat panels. According to a widespread classification, real flat panels are characterized by a radius of outside curvature higher than 20,000 mm, whereas conventional panels are characterized by a radius of outside curvature lower than 10,000 mm.

Generally, real flat panels weigh more than conventional panels, not only as a result of differences in size, but also as a result of differences in the thickness of the glass. The glass thickness of real flat panels needs to be larger than the glass thickness of conventional panels, mainly due to the fact that real flat panels are subjected to a higher vacuum tensile stress when these panels are utilized in a cathode ray tube. This is a result of the flatness of the front surface of the real flat panel, as stress distribution on a flat surface is unfavorable in comparison with stress distribution on a curved surface. Furthermore, in certain types of cathode ray tubes, it is required that the glass thickness at the periphery of the display window is larger than the glass thickness at the center face of the display window, in order to obtain a flat image on the front surface of the display window during operation of these cathode ray tubes. For example, it may be required that the so-called wedge, that is the difference between the periphery thickness and the center face thickness, is larger than 5 mm.

The large weight of the panel is an important disadvantage because it makes handling of the panel during its manufacturing process more difficult and because it leads to a large weight for the cathode ray tube. Furthermore, thermal processing of the panel takes a relatively large amount of time. As a consequence, the costs involved in the manufacturing process of cathode ray tubes comprising real flat panels are relatively high. In the field of cathode ray tubes, it is therefore an ongoing issue to reduce the glass thickness of real flat panels.

It is generally known that the glass thickness can be reduced by submitting a panel to a thermal strengthening process, whereby a compressive stress layer on the surface of the panel is obtained. In the process, the strength of the surface is increased and the chance of breakage is reduced. Therefore, the glass thickness of panels provided with such a compressive stress layer can be smaller.

However, during the thermal strengthening process, an uneven temperature distribution occurs on the surface of the panel. With regard to the specific design of the panel, it will be understood that the center face of the display window cools down faster than the periphery of the display window, in particular the corners on the inside surface of the display window. In real flat panels, this effect is reinforced by the fact that the glass thickness at the periphery is larger than the glass thickness at the center face. As the compressive stress relates directly to the cooling rate, a panel having an uneven stress distribution over its surface is obtained, wherein the compressive stress at the corners on the inside surface of the display window is low in comparison with the compressive stress at the center face on the inside surface of the display window. This particular stress distribution influences the strength and also the mechanical safety of the panel in a negative way, so that eventually the chance of breakage is reduced not as much as would be expected when applying compressive stress layers.

It is an object of the present invention to further improve the mechanical safety and the strength of real flat panels, so that the glass thickness of the panels or portions of the panels may be further reduced. An increase of the strength of the panels may improve the yield. Also, it is an object of the present invention to improve the stress distribution over the inside surface of real flat panels. According to the invention, at least the first of these objects is achieved by means of a panel meeting the following stress distribution criterion: S_{icor}>S_{icf} where S_{icor} is a compressive inside surface stress at a corner of the display window and S_{icf} is a compressive inside surface stress at a center face of the display window.

According to the invention, the stress distribution is such that S_{icor} is higher than S_{icf}. Consequently, in real flat panels having a wedge, the compressive inside surface stress at a thicker portion of the panels is higher than the compressive inside surface stress at a thinner portion. With regard to the process of linking the panel and a funnel in order to obtain a cathode ray tube, this stress distribution is advantageous as, during this process, tensile surface stresses are introduced, which naturally have the effect of reducing the compressive surface stresses. In the process, an uneven temperature distribution occurs on the surface of the panel, as a result of which an uneven distribution of the tensile surface stresses over the surface of the panel is obtained, i.e. the tensile surface stresses are higher at thicker portions of the panel than at thinner portions. Thus, in real flat panels, the tensile surface stresses introduced are higher at the periphery of the display window than at the center face of the display window. As the compressive surface stresses are distributed over the surface of the display window in a comparable manner, the reducing effect of the tensile stresses introduced is more or less the same for all portions of the panel. Therefore, resulting surface stresses may be more or less evenly distributed over the surface of the panel. As a result of this advantageous resulting stress distribution, the glass thickness of the panel may be reduced, at least locally, while at the same time the mechanical safety of a cathode ray tube comprising such a thinner panel still meets the safety requirements.

The invention will now be explained in greater detail with reference to the Figures, in which similar parts are indicated by the same reference signs, and in which:

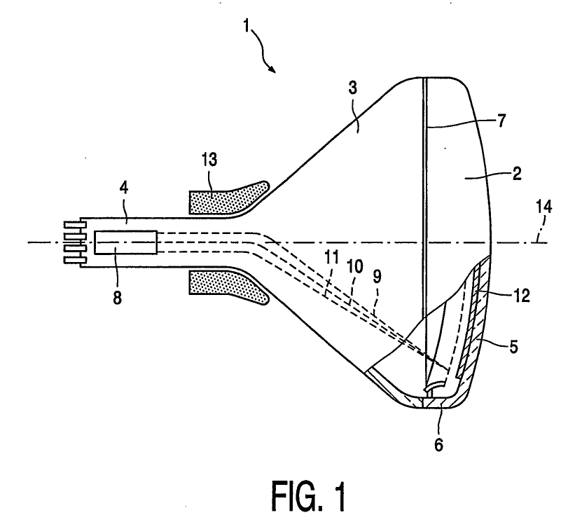

FIG. 1 is a partial longitudinal sectional view of a cathode ray tube;

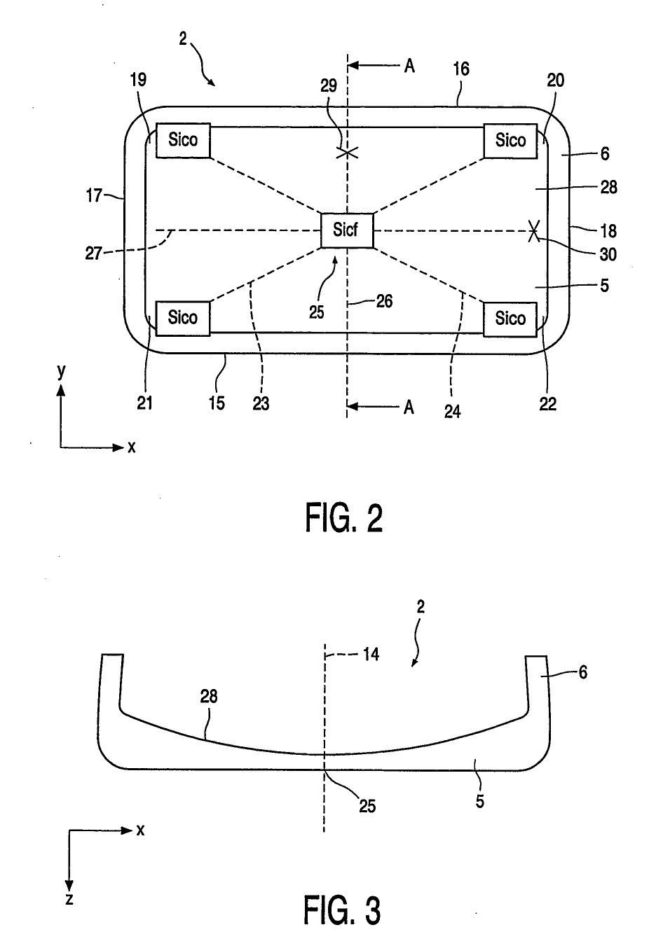

FIG. 2 is a front view of the inside of a panel being intended for use in a cathode ray tube as shown in FIG. 1; and

FIG. 3 is a longitudinal sectional view of the panel taken on the line A-A of FIG. 2.

The figures are purely diagrammatic and not drawn to scale. In particular, for the sake of clarity, some dimensions are exaggerated.

FIG. 1 is a longitudinal sectional view of a cathode ray tube 1 comprising a glass envelope having a panel 2, a cone 3 and a neck 4. The panel 2 comprises a substantially rectangular display window 5 and an upright edge 6. The upright edge 6 of the panel 2 is joined to a front end 7 of the cone 3, for example by means of fritting.

The neck 4 accommodates an electrode system 8 having three electron guns for generating three electron beams 9, 10, 11. The electron beams 9, 10, 11 are directed towards a rectangular display screen 12 which is provided on the inside of the display window 5 and which comprises a large number of red, green and blue luminescing phosphor elements being laid down in narrow bands. On their way to the display screen 12, the electron beams 9, 10, 11 are deflected by deflection coils 13 which are coaxially arranged about a longitudinal axis 14 of the cathode ray tube 1.

FIGS. 2 and 3 show the panel 2 in a certain stage during its production process, wherein the luminescing phospor elements have not yet been laid down on the inside of the display window 5.

In the following, a z-direction is defined as the direction in which the longitudinal axis 14 extends. An x-direction and a y-direction which is perpendicular to the x-direction are defined as directions in a plane perpendicular to the z-direction. The x-direction corresponds to a direction in which two opposite long sides 15, 16 of the display window 5 extend, whereas the y-direction corresponds to a direction in which two other opposite short sides 17, 18 of the display window 5 extend, the latter direction corresponding to the direction in which the luminescing phosphor elements are to be laid down on the display window 5 during a later stage of the production process of the panel 2.

Corners 19, 20, 21, 22 of the display window 5 are defined as regions situated at the location where the long sides 15, 16 and the short sides 17, 18 meet each other. Diagonals 23, 24 of the display window 5 are defined as imaginary lines which extend from one corner 19, 21 to another corner 20, 22 and which do not extend in a direction parallel to one of the sides 15, 16, 17, 18. A center face 25 of the display window 5 is defined as a region situated at the location where the diagonals 23, 24 intersect. A short central axis 26 is defined as an imaginary line which extends parallel to the short sides 17, 18 of the display window 5, with the x-position of the short central axis 26 corresponding to the x-position of the intersection of the diagonals 23, 24. A long central axis 27 is defined as an imaginary line which extends parallel to the long sides 15, 16 of the display window 5, with the y-position of the long central axis 27 corresponding to the y-position of the intersection of the diagonals 23, 24. In FIGS. 2 and 3, an inside surface of the display window 5 is indicated by reference numeral 28. In FIG. 3, a particular type of panel design having a wedge is diagrammatically shown, wherein the glass thickness at the periphery of the display window 5 is larger than the glass thickness at the center face 25 of the display window 5. The wedge may for example be larger than 5 mm.

The panel 2 shown may be a real flat panel, wherein for example the diagonals 23, 24 are longer than 500 mm and a radius of outside curvature is higher than 20,000 mm.

According to the invention, a compressive inside surface stress S_{icor} at a corner 19, 20, 21, 22 of the display window 5 is higher than a compressive inside surface stress S_{icf} at the center face 25 of the display window 5. In FIG. 2, the positions where S_{icor} and S_{icf} act on the display window 5 are diagrammatically depicted by means of rectangles.

An important advantage of this particular stress distribution is that it allows for a relatively fast heating process when the panel 2 and a cone 3 are joined during the production process of a cathode ray tube 1. The main reason for this advantageous effect of this particular stress distribution is that it is on the whole comparable to the distribution of tensile surface stresses which occur during such a heating process. This distribution is such that the tensile surface stresses introduced are higher at the periphery than at the center face 25, due to the particular temperature distribution which occurs on the surface of the display window 5 during the heating process. This temperature distribution is mainly determined by the particular design of the panel 2, wherein the wedge is of influence. Further, in general, the faster the heating process, the higher the introduced tensile stresses are. Therefore, in comparison with a panel 2 having substantially no surface stresses, the heating process can be performed much faster, since the tensile surface stresses introduced are at least partly nullified by the compressive surface stresses already present. In comparison with a panel 2 having another distribution of compressive surface stresses, the heating process can also be performed faster, since the reducing effect of the tensile surface stresses introduced is more evenly distributed over at least the inside surface 28 of the display window 5.

Preferably, the stress distribution over the display window 5 is such that the following is true for the ratio of S_{icor}/S_{icf}: 1.05≦S_{icor}/S_{icf}≦2.0.

Preferably, the panel additionally meets the following stress distribution criterion: S_{ca}≦2 Mpa, where S_{ca} is a through-thickness integral stress measured at an end of a central axis 26, 27 of the display window 5. Generally, a stress having a positive sign is to be interpreted as a tensile stress, whereas a stress having a negative sign is to be interpreted as a compressive stress. Therefore, the above-mentioned preferred stress distribution criterion implies that S_{ca} is a relatively very low tensile stress or even a compressive stress, which is advantageous as far as the safety of the panel 2 is concerned. In FIG. 2, an end 29 of the short central axis 26 and an end 30 of the long central axis 27 are diagrammatically depicted by means of crosses.

The value of S_{ca} at a certain x,y-position is the average of the values of so-called membrane stresses which are measured along the thickness of the display window 5. These membrane stresses are the result of differences in cooling rates between a central portion and a peripheral portion of the display window 5, which occur as a result of the wedge during the cooling process which takes place after the panel 2 has been obtained by pressing. The central portion cools down at an earlier stage, whereas the peripheral portion shrinks around the central portion at a later stage, thereby giving rise to a stress difference between the central portion and the peripheral portion.

The stress distribution according to the invention may be obtained by means of a recently developed cooling method, wherein the heat losses in the central portion of the display window 5 are suppressed by means of a reflection shield during cooling down of a pressed panel 2. By suppressing the heat losses at the center of the display window 5, the temperature difference between center and periphery will decrease and hence S_{ca} will decrease and the ratio of S_{icor}/S_{icf} may become higher than 1.0, while remaining lower than 2.0.

In the following table, non-restricting examples are given of resulting values of S_{icf}, S_{icor} and S_{ca} in a particular type of panel 2 after it has been submitted to the cooling method. S_{ca} has been measured at the end 29 of the short central axis 26. The following conditions apply:
1) the panel 2 is a real flat panel (type 29 RF), wherein the length of the long sides 15, 16 of the display window 5 is 600 mm and wherein the length of the short sides 17, 18 of the display window 5 is 470 mm;
2) initially, the panel 2 is at a temperature of 580° C.;
3) the panel 2 is cooled down in a cooling lehr which has a constant cooling rate; and

4) reflection plates (400 mm×300 mm) are arranged opposite to the central portion of the display window 5 and are used to suppress the heat losses at this central portion.

TABLE
measured stresses [MPa]

| Panels 29 RF | S_{icf} | S_{icor} | S_{icor}/S_{icf} | S_{ca} |
|---|---|---|---|---|
| rate = 0.1° C./s | −3.0 | −5.8 | 1.93 | −1 |
| rate = 0.2° C./s | −5.0 | −7.5 | 1.50 | +2 |
| rate = 0.3° C./s | −7.1 | −9.3 | 1.31 | −1 |
| rate = 0.4° C./s | −8.2 | — | — | +1 |
| rate = 0.5° C./s | −8.2 | −12.1 | 1.48 | +1.5 |

It is clear from the table that panels 2 are obtained in which S_{icor} is higher than S_{icf}, and for which the ratio of S_{icor}/S_{icf} is between 1.05 and 2.0 for all cooling rates. Further, it is clear that S_{ca} does not exceed 2 MPa for all cooling rates.

Due to the advantageous ratio of S_{icor}/S_{icf}, a relatively strong panel 2 which easily meets the safety requirements is obtained. Therefore, the glass thickness of the panel 2 may at least locally be smaller and/or the thermal processing speeds may be higher, as the induced thermal tensile stresses during cathode ray tube manufacturing are compensated for, as already explained in the above.

Besides, the relatively low tensile value or compressive value of S_{ca} also has a positive influence on the strength and the mechanical safety of the panel 2.

Additionally, the panel 2 according to the present invention may be provided with a rim band (not shown) serving as an anti-implosion band for providing strength against mechanical shock. Such a rim band is normally arranged around the upright edge 6 of the panel 2. As the stress distribution according to the present invention provides a stronger panel 2, the tension of the rim band may be reduced.

In short, the invention relates to a glass panel 2 for a cathode ray tube 1, in particular a real flat panel, comprising a substantially rectangular display window 5 having an upright edge 6 along its periphery.

The glass panel 2 meets the following stress distribution criterion: S_{icor}>S_{icf}. Preferably, the ratio of S_{icor}/S_{icf} is higher than or equal to 1.05 and lower than or equal to 2.0.

As a result of this particular stress distribution, the strength and the mechanical safety of the panel 2 are increased, so that the glass thickness of the panel 2 and/or thermal processing speeds may be reduced.

In addition to the above-described stress distribution, the invention proposes that S_{ca} is smaller than or equal to 2 MPa.

It will be clear to a person skilled in the art that the scope of the present invention is not limited to the examples discussed in the foregoing, but that several amendments and modifications thereof are possible without deviating from the scope of the invention as defined in the appended claims.

1. Glass panel for a cathode ray tube, comprising a substantially rectangular display window having an upright edge along its periphery, the glass panel meeting the following stress distribution criterion:
S_{icor}>S_{icf}
where S_{icor} is a compressive inside surface stress at a corner of the display window and S_{icf} is a compressive inside surface stress at a center face of the display window.

2. Glass panel according to claim 1, wherein
1.05<S_{icor}/S_{icf}≦2.0.

3. Glass panel according to claim 1, further meeting the following stress distribution criterion:
S_{ca}≦2 MPa
where S_{ca} is a through-thickness integral stress measured at an end of a central axis of the display window.

4. Glass panel according to claim 1, wherein a radius of outside curvature of the display window is higher than 20,000 mm.

5. Glass panel according to claim 1, wherein a diagonal of the panel is larger than 500 mm.

6. Glass panel according to claim 1, wherein the glass thickness at the periphery of the display window is larger than the glass thickness at the center face of the display window.

7. Glass panel according to claim 6, wherein the difference between the glass thickness at the periphery of the display window and the glass thickness at the center face of the display window is more than 5 mm.
